(19) United States
(12) Patent Application Publication
(10) Pub. No.: US 2007/0131254 A1
(43) Pub. Date: Jun. 14, 2007

(54) Washing apparatus with bubbling reaction and a washing method of using bubbling reaction

(75) Inventors: Kon-Tsu Kin, Hsinchu (TW); Chiou-Mei Chen, Hsinchu (TW); Ching-Yi Hsu, Hsinchu (TW); Yung-Chi Kuo, Hsinchu (TW)

Correspondence Address: BIRCH STEWART KOLASCH & BIRCH, PO BOX 747, FALLS CHURCH, VA, 22040-0747, US

(73) Assignee: Industrial Technology Research Institute

(21) Appl. No.: 11/417,032

(22) Filed: May 4, 2006

(30) Foreign Application Priority Data
Dec. 13, 2005 (TW) 94144147

(51) Int. Cl. B08B 3/00; B08B 3/12

(52) U.S. Cl. 134/26; 134/94.1; 134/34; 134/184

(57) ABSTRACT

The present invention relates to a washing apparatus with bubbling reaction and a washing method of using bubbling reaction which are based on compression technology of an interface diffusion layer with bubbling, by the aid of using a bubble wall generated by a pneumatic means as a reaction interface in a gas-liquid-solid heterogeneous system and utilizing a pulling force generated by bubbles when climbing up along the surface of a material to be washed, to compress thickness of the liquid-solid interface and optimize mass transfer efficiency in multiphase that can remove organic matter from the material surface.

### FIELD OF THE INVENTION

The present invention relates to a washing apparatus which is used to remove organic matter from a specific material. Particularly, the present invention directs to a washing apparatus with bubbling reaction through ozone and a washing method of using such reaction.

### BACKGROUND OF THE INVENTION

Heterogeneous reaction systems widely exist in various industries, for instance, catalytic reaction systems and long-film processes for high level electronic components. To raise heterogeneous mass transfer efficiency in multiphase is important to develop technology related process. In a heterogeneous reaction system in which gas-liquid-solid phases coexist, because the reaction needs to be conducted through interfaces of the both gas-liquid and liquid-solid phases, the thickness of an interface diffusion layer and the replacing frequency in the reaction interface become a critical bottleneck to affect the reaction rate.

Conventional technology commonly uses certain of manipulations such as a mechanical stirring, an ultrasonic wave, or an ultrasonic vibration to compress the thickness of the interface and increase the mass transfer efficiency. However, in a heterogeneous reaction system that a liquid phase exists in a large proportion and a gas phase belongs to a hardly-soluble gas, a critical step affecting the reaction rate mainly depends on the mass transfer rate between gas-liquid interfaces. The mechanical stirring cannot effectively compress the interface, and thus a restricted effect on the mass transfer diffusion can be accomplished. Recently, there is also a new research that utilizes a centrifugal force generated by high-speed rotation to centrifugally remove a water layer from a surface of a solid which can compress the thickness of water film and replace a contact interface. Nevertheless, this method has restrictions on the shape, size and dimension of a material to be treated because it needs to consume a larger electrical energy, and in addition, the high-speed rotation operating for a long time may cause a concern about generating pollution of micro-particles.

At present, a method for controlling the interface diffusion layer in the heterogeneous system has not been published in the international research yet. Regarding a photoresist washed by aqueous ozone and its related equipment, the prior art describes the following technology.
1. A part of a substrate is directly soaked in a solution while gaseous ozone is introduced. The aqua solution brought by rotating the substrate can form a thin film on the surface of the substrate and then remove a photoresist.
2. The interface between heterogeneous phases is compressed by spraying aqueous ozone and rotating a substrate in high speed.
3. In addition to aqueous ozone, other solutions such as de-ionized water (DI-water), sulfuric acid, hydrochloric acid, aqueous ammonia, and so on are used which simultaneously mix with ozone in conjunction with an ultrasonic vibration.
4. Ozone vapor formed by an aqueous solution at a high temperature is used to remove the photoresist.
5. A substrate is heated by ultraviolet (UV) ray in conjunction with ozone to conduct a dry cleaning.

These methods all needs to be conducted under conditions of a high-speed rotation, a high-temperature heating, an ultraviolet (UV) ray, or some additional oxidants, chemical solutions, etc. Especially, the operation of high-speed rotation has high restrictions on its applications because it has a great concern for a nanometer process. Specifically, the operation of high-speed rotation has strict requirements for size, shape, and symmetry of placement of a material to be treated and may generate pollution of micro-particles.

How to effectively use an ozone gas-liquid system for washing is a valuable technology worthy to think over.

According to the currently known technology, using sulfuric acid for washing is the oftenest used means which, however, has flaws in high-temperature (120° C.) process, a large amount of water consumption and discharging waste acid, and hard to treat a material containing a metal layer. In other words, the means deeply consumes resources and is not environmental protection.

### SUMMARY OF THE INVENTION

The main objective of the present invention is to provide a washing apparatus with bubbling reaction and a washing method of using bubbling reaction that resolve the restrictions on the current technology. The present invention utilizes a concept of compression technology of an interface diffusion layer with bubbling which is applied to design a washing process of a reaction tank removing organic matter. Under operational conditions of saving water and energy without rotating the substrate in high-speed, the present invention can efficiently remove the organic matter from a substrate surface.

To accomplish the above objective, the present invention provides a washing apparatus with bubbling reaction and a washing method of using bubbling reaction, wherein the washing apparatus with bubbling reaction comprises a reaction tank to contain washing solution and simultaneously is installed with other working units for generating bubbles in the washing solution and for controlling the temperature of the washing solution and controlling the means of rotating a substrate during washing. Since the present invention can be manipulated under conditions of saving water and energy without rotating the substrate in high-speed, it can be carried out at ambient temperature and pressure without a concern about generating pollution of micro-particles and is highly flexible to the size of a material to be treated.

Moreover, the present invention can apply to remove a lithography photoresist in various industries such as semiconductor, thin film transistor-liquid crystal display (TFT-LCD), micro/nanometer precision machined mold and so on, as well as to a process of washing a surface of the other material. In the future, the present invention can also apply to disinfect medical equipments or wash a surface of nanometer material during its production.

### BRIEF DESCRIPTION OF FIGURES

To further illustrate the above objectives, structural characteristics and functions of the present invention, detailed descriptions are disclosed as follows by reference to accompanying drawings, in which

FIG. 1 shows a structure of a washing apparatus with bubbling reaction according to one embodiment of the present invention.

FIG. 2A and 2B is a flow chart illustrating washing method of using bubbling reaction according to the present invention.

### DETAILED DESCRIPTION OF THE INVENTION

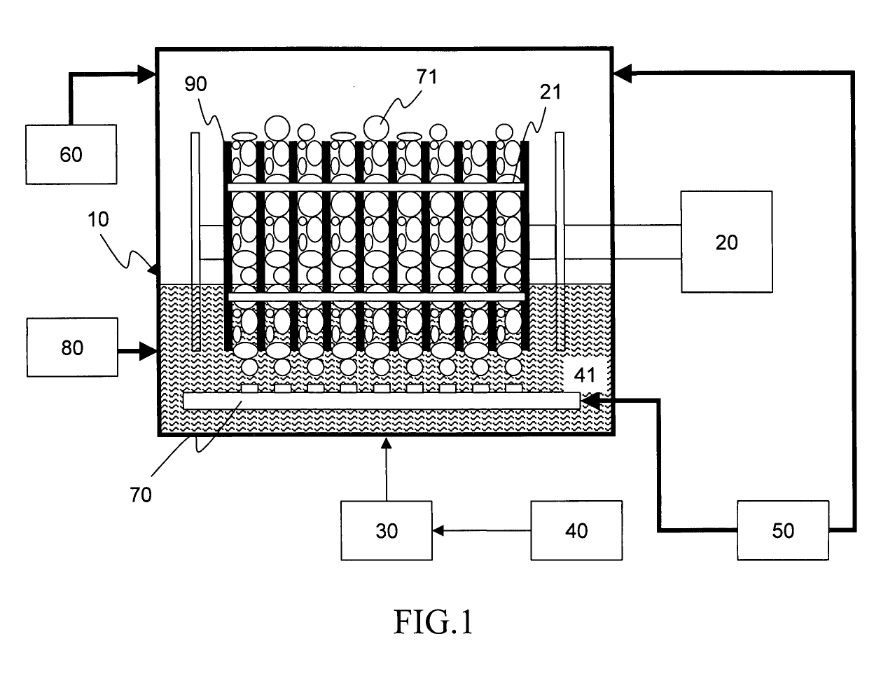

The present invention discloses a washing apparatus with bubbling reaction which uses a bubbling reaction to remove organic matter from the surface of a substrate. First, please refer to FIG. 1 which shows a structure of a washing apparatus with bubbling reaction according to one embodiment of the present invention.

The washing apparatus with bubbling reaction of the present invention comprises a reaction tank 10, a motion unit 20, a temperature-control system 30, a source 40 for supplying reaction liquid, a source 50 for supplying reaction gas, a pressure-control system 60, a bubble-generating means 70, and a source 80 for supplying washing solution. The reaction tank 10 is used to place a substrate 90 and provide a space for washing the substrate 90. The substrate 90 is placed on the motion unit 20, which lets the substrate 90 generate rotational displacement in the reaction tank 10 during washing. The source 50 for supplying reaction gas is used to supply the reaction tank 10 with the reaction gas, and the source 40 for supplying reaction liquid is used to supply the reaction liquid to the temperature-control system 30. After receiving the reaction liquid, the temperature-control system 30 controls the temperature of the reaction liquid and then supplies the reaction liquid at an appropriate temperature to the reaction tank 10.

The reaction liquid forms a horizontal plane in the reaction tank 10 and completely covers the bubble-generating means 70. The bubble-generating means 70 can be a pipe made from material capable against the erosion of ozone, on the pipe at least one exhaust outlet is installed to exhaust the gas or the means 70 can be made from a gas distributor disc. After receiving the reaction gas, the bubble-generating means 70 supplies the gas to the reaction liquid to generate bubbles 71. The pressure-control system 60 also connects with the reaction tank 10 and is used to control the pressure in the reaction tank 10 and, after the reaction is completed, extract the surplus reaction gas from the reaction tank 10. The washing procedure can then be carried out after the organic matter is successfully removed from the substrate 90. At this moment, a source 80 for supplying washing solution can provide the washing solution to wash the substrate 90. The washing procedure can be finished in the reaction tank 10 or accomplished in another washing tank by transferring the substrate 90 to another tank.

In order to attain a good effect on removal, the foregoing reaction gas can use ozone or a mixed gas containing ozone. The ozone can be generated by a high-voltage electric field or ultraviolet (UV) irradiation. When the reaction gas enters into the reaction tank 10, the concentration of the reaction gas is preferably 1% to 17%. The reaction liquid 81 can be selected from de-ionized water (DI-water), aqueous ozone, or an aqueous solution having an appropriate pH adjusted by HCl, H₂SO₄, NH₄OH, and so on with a temperature of from room temperature to 80° C. The generated bubbles 71 may climb up along the substrate 90 which has already been fastened on the motion unit 20 by the fixed means 2 1. The motion unit 20 can generate rotational motion with the rotational rate ranging from 1 to 10 rpm to rotate the substrate 90. The motion unit 20 can be designed to rotate itself together with the substrate 90 or only to rotate the substrate 90.

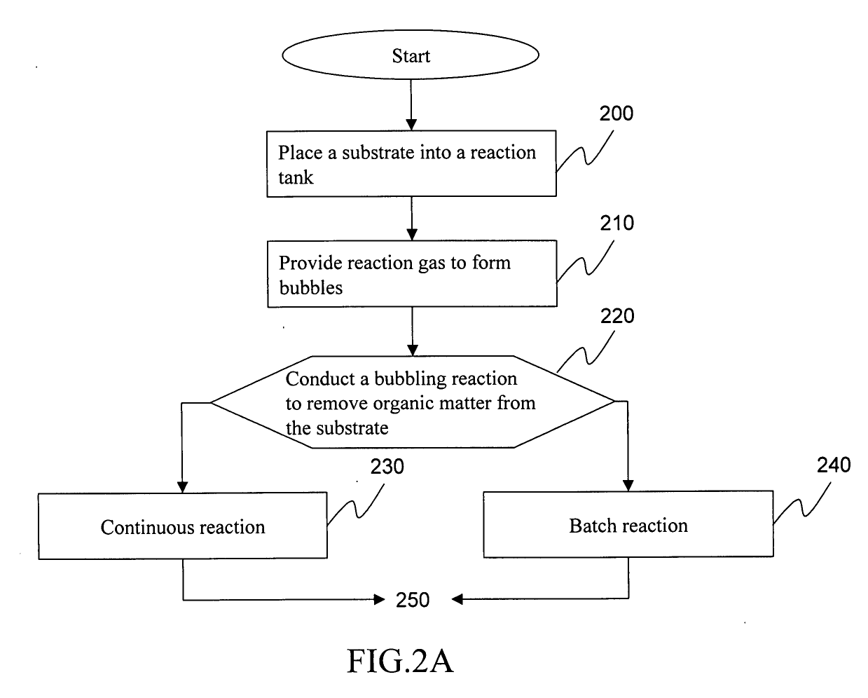

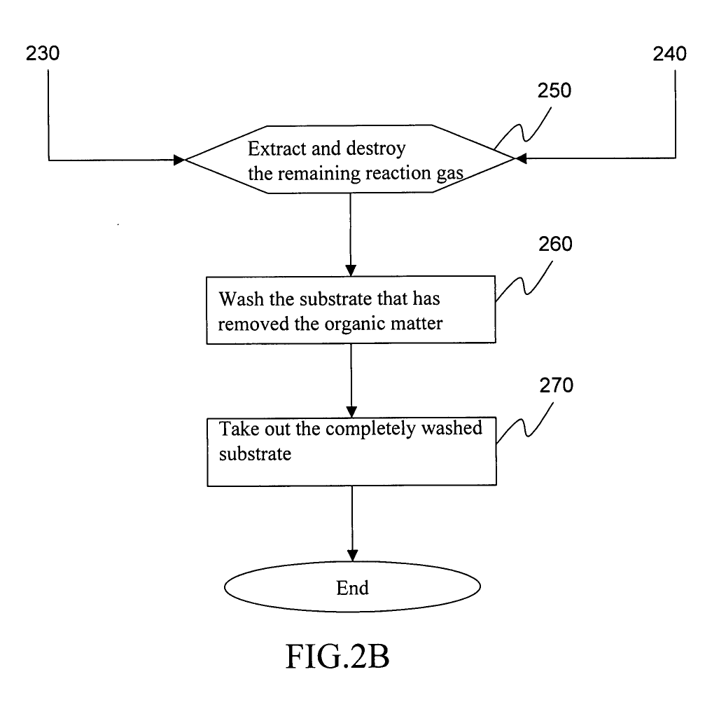

Next, please refer to FIG. 2A which shows a flow chart (1) illustrating washing method of using bubbling reaction according to the present invention.

Supposing a semiconductor wafer or a glass substrate is used as the substrate, when the substrate needs to be washed due to a photoresist or any organic contaminant during its production, the substrate is firstly placed into the reaction tank (Step 200). Subsequently, the reaction gas is supplied to form bubbles (Step 210) where the reaction gas needs to be supplied in appropriate concentration and flow rate and further delivered through the reaction liquid at an appropriate temperature to generate bubbles. The bubbling reaction is carried out afterward to remove the organic matter from the substrate (Step 220). At this moment, the bubbles may climb up along a surface of the substrate and remove the organic matter from the surface of the substrate. This procedure can be done by either a continuous reaction (Step 230) or a batch reaction (Step 240). After the reaction is completed, the remaining reaction gas is extracted and destroyed (Step 250). Then, the washing procedure is conducted; namely, the washing solution is used to wash the substrate on which surface the organic matter has been removed (Step 260). The washing procedure can be finished in the original reaction tank or accomplished in another washing tank by transferring the substrate to the washing tank. Finally, the completely washed substrate is taken out from the tank (Step 270) to finish the whole process. Now please refer to FIG. 2B which shows a flow chart (2) illustrating washing steps of using the washing apparatus with bubbling reaction of the present invention.

In the reaction process of removing the organic matter, part of the substrate needs to be soaked in the reaction liquid. The height of the water level that the substrate soaks in the reaction liquid preferably occupies 5% to 80% of the diameter of the substrate. Meanwhile, the angle between the substrate and the plane of the reaction liquid is preferably in a range of from 5° to 90°. The exhaust outlet of the reaction gas needs to locate below the substrate and the reaction liquid in order to ensure generating the bubbles successfully. When Step 220 carries out, the substrate may further need rotational motion to ensure the effect on removing the organic matter. The rotational motion can set the rotational rate between 1 rpm and 10 rpm. The continuous reaction (Step 230) and the batch reaction (Step 240) can be optionally selected depending on situations, and the differences between these reactions are as follows.
The continuous reaction means that all the conditions are invariable in the whole reaction process, for example, the concentration and the flow rate of the reaction gas, the temperature of the reaction liquid, the water level for soaking the substrate, the rotational rate of the substrate, and the angle between the substrate and the plane of the reaction liquid.
The batch reaction means that the whole bubbling reaction process can be conducted by dividing into several steps, each of which can carry out under a different concentration and a different flow rate of the reaction gas, a different temperature of the reaction liquid, a different rotational rate of the substrate, and a different angle between the substrate and the plane of the reaction liquid.

In the final washing procedure, the washing solution has no special restriction on entering into the reaction tank and can be infused from the top or the bottom. The means of washing can be selected from soaking, showering, or spraying.

Moreover, the method of the present invention utilizes gaseous ozone to naturally form a bubble wall in liquid as a reaction interface in a gas-liquid-solid heterogeneous system. Without rotating the substrate in a high-speed, the bubbles are generated by a pneumatic means and climb up along a surface of a material to be washed. In a pull process when the bubbles climb up, the liquid-solid interface can be compressed to a minimal thickness and thus mass transfer efficiency in multiphase can be increased that can remove the organic contaminants effectively. The method of the present invention has advantages of saving water and energy, carrying out at ambient temperature and pressure without rotating the substrate in high-speed and without a concern about micro-particle pollution, and being flexible to the size and the type of material to be treated.

Although the present invention is exemplified by the above preferable embodiment, it does not intend to use to restrict the scope of the present invention. Person skilled in the art can make a certain modification and change without departing from the sprit and scope of the present invention. Therefore, it is necessary to define the scope of the present invention based on the claims described below.

What is claimed is:

1. A washing apparatus with bubbling reaction, which uses a bubbling reaction to remove organic matter from the surface of a substrate and includes
a reaction tank, which is used to place said substrate and provide said substrate with washing space;
a source for supplying a reaction gas, which connects with said reaction tank and supplies said reaction tank with a reaction gas;
a source for supplying reaction liquid;
a temperature-control system, which connects with said source for supplying reaction liquid, and controls the temperature of said reaction liquid, and then supplies said reaction liquid to said reaction tank;
a bubble-generating means, which generate bubbles in said reaction gas after receiving in the reaction liquid;
a motion unit, which is used to let said substrate generate rotational displacement in said reaction tank;
a pressure-control system, which connects with said reaction tank, controls the pressure in the reaction tank, and extracts said surplus reaction gas from said reaction tank; and
a source for supplying a washing solution, which supplies the washing solution to wash said substrate after said organic matter is removed.

2. A washing apparatus with bubbling reaction according to claim 1, wherein said reaction gas is selected from the group consisting of ozone and a mixed gas containing ozone.

3. A washing apparatus with bubbling reaction according to claim 2, wherein the concentration of said reaction gas in the reaction liquid is in a range of from 1% to 17%.

4. A washing apparatus with bubbling reaction according to claim 2, wherein said ozone is generated by using a high-voltage electric field and/or ultraviolet (UV) irradiation.

5. A washing apparatus with bubbling reaction according to claim 1, wherein said reaction liquid is selected from the group consisting of de-ionized water (DI-water), aqueous ozone, and a solution adjusted at an appropriate pH by adding HCl, H₂SO₄ or NH₄OH.

6. A washing apparatus with bubbling reaction according to claim 1, wherein said temperature-control system controls the temperature of said reaction liquid in the range of from room temperature to 80° C.

7. A washing apparatus with bubbling reaction according to claim 1, wherein said reaction tank hold said reaction liquid forming a horizontal plane interiorly.

8. A washing apparatus with bubbling reaction according to claim 1, wherein said motion unit further comprises a fixed means for fixing said substrate on said motion unit.

9. A washing apparatus with bubbling reaction according to claim 1, wherein said rotational displacement is rotational motion with the rotational rate ranging from 1 to 10 rpm.

10. A washing apparatus with bubbling reaction according to claim 1, wherein said bubble-generating means is a pipe made from a material capable against erosion of ozone on which surface at least one exhaust outlet is installed or said bubble-generating means is a gas distributor disc, and said bubble-generating means is located below said horizontal plane of said reaction liquid.

11. A washing apparatus with bubbling reaction according to claim 1, wherein after removing said organic matter, said substrate is subjected to a washing procedure in said reaction tank or in another washing tank.

12. A washing method of using bubbling reaction, which uses a bubbling reaction to remove organic matter from a surface of a substrate and includes the steps of
placing said substrate into a reaction tank and supplying a reaction gas at appropriate concentration and flow rate;
delivering said reaction gas through a reaction liquid with an appropriate temperature to generate bubbles;
allowing said bubbles climb up along said surface of said substrate and remove said organic matter from said surface of said substrate; and
allowing said substrate conduct a washing procedure by using a washing solution.

13. A washing method of using bubbling reaction according to claim 1, wherein part of said substrate is soaked in said reaction liquid, and the height of the water level soaking said substrate occupies from 5% to 80% of the diameter of said substrate.

14. A washing method of using bubbling reaction according to claim 13, wherein the angle between said substrate and the plane of said reaction liquid is in a range of from 5° to 90°.

15. A washing method of using bubbling reaction according to claim 12, wherein said organic matter from said substrate is further assisted with a rotational motion at a rotational rate in the range of from 1 rpm to 10 rpm.

16. A washing method of using bubbling reaction according to claim 12, wherein the exhaust outlet of said reaction gas is located below said substrate and said reaction liquid.

17. A washing method of using bubbling reaction according to claim 12, wherein said substrate is a semiconductor wafer or a glass substrate.

18. A washing method of using bubbling reaction according to claim 12, wherein said organic matter is a photoresist or organic contaminant during its production.

19. A washing method of using bubbling reaction according to claim 12, wherein said rotational motion, the concentration of said reaction gas, the flow rate of said reaction gas, the temperature of said reaction liquid, and the height of the water level of said reaction liquid is optionally varied at any time during removing said organic matter.

20. A washing method of using bubbling reaction according to claim 12, wherein said reaction gas is selected from the group consisting of ozone and a mixed gas containing ozone.

21. A washing method of using bubbling reaction according to claim 20, wherein the concentration of said reaction gas is in a range of from 1% to 17%.

22. A washing method of using bubbling reaction according to claim 20, wherein said ozone is generated by using a high-voltage electric field and/or an ultraviolet (UV) irradiation.

23. A washing method of using bubbling reaction according to claim 12, wherein said reaction liquid is selected from the group consisting of deionized water (DI-water), aqueous ozone, and a solution adjusted at an appropriate pH by using HCl, H₂SO₄ or NH₄OH.

24. A washing method of using bubbling reaction according to claim 12, wherein the temperature of said reaction liquid is in a range of from room temperature to 80° C.

25. A washing method of using bubbling reaction according to claim 12, wherein said washing solution entering into said reaction tank is infused either from the top or from the bottom.

26. A washing method of using bubbling reaction according to claim 12, wherein said washing procedure can be carried out by soaking, showering, or spraying.
